(19) United States
(12) Patent Application Publication
(10) Pub. No.: US 2009/0147305 A1
(43) Pub. Date: Jun. 11, 2009

(54) Image Forming Apparatus Having a Function of Mediating Data Transmission Between a Reception Part and a Job Execution Part

(75) Inventor: Toru Zushi, Tokyo (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/323,574

(22) Filed: Nov. 26, 2008

(30) Foreign Application Priority Data
Dec. 6, 2007 (JP) 2007-316130

(51) Int. Cl. G06F 3/12

(52) U.S. Cl. 358/1.15

(57) ABSTRACT

An image forming apparatus has at least one job execution part that executes a job based on data received according to a print protocol. A data reception part receives data transferred according to the print protocol. The data reception part exists depending on a kind of the print protocol. A mediation part mediates transmission of the data between the data reception part and the job execution part.

### BACKGROUND OF THE INVENTION

1. Field of the Invention

The present invention generally relates to an information processing technique and, more particularly, to an image data transmission method performed by an image forming apparatus.

2. Description of the Related Art

A server program referred to as a protocol daemon is used in image forming apparatuses such as a printer, a multi-function peripheral, etc. The protocol daemon is used in receiving print data, which is transferred through a network using a print protocol. The print data received by the protocol daemon is interpreted by a higher-order application, and a print job is executed using the interpreted print data. Such a protocol daemon is disclosed in the following Patent Documents.

Patent Document 1: Japanese Patent Publication No. 3710789

Patent Document 2: Japanese Laid-Open Patent Application No. 2006-056027.

There are a plurality of kinds of print protocols used in image forming apparatuses, and there is a protocol daemon for each kind of print protocol. Accordingly, it is possible to cause an image forming apparatus to handle a plurality of kinds of print protocols or change a print protocol which is to be used. In such a case, it is not preferable to be given an influence of changes in a protocol daemon structure on a higher-order application side from the viewpoint of versatility of application-executing circumstances.

Thus, it is desirable to reduce an influence given by a difference in a protocol daemon structure with respect to an application executing a print job based on print data.

### SUMMARY OF THE INVENTION

There is provided according to one aspect of the present invention an image forming apparatus having at least one job execution part that executes a job based on data received according to a print protocol, the image forming apparatus comprising: a data reception part configured to receive data transferred according to the print protocol, the data reception part existing depending on a kind of the print protocol; and a mediation part configured to mediate transmission of the data between the data reception part and the job execution part.

There in provided according to another aspect of the present invention an information processing method performed by an image forming apparatus having at least one job execution part that executes a job based on data received according to a print protocol, the information processing method comprising: a data reception procedure to receive data transferred according to the print protocol by a data reception part existing depending on a kind of the print protocol; and a mediation procedure executed by a mediation part to mediate transmission of the data between the data reception part and the job execution part.

According to the present invention, an influence given to an application, which executes a print job based on print data, due to a difference in a structure of a protocol daemon can be reduced.

### BRIEF DESCRIPTION OF DRAWINGS

FIG. 1 is a block diagram of a hardware structure of a multi-function peripheral according to an embodiment of the present invention;

FIG. 2 is an illustration showing a software structure of the multi-function peripheral;

FIG. 3 is an illustration showing a structure of software components of the multi-function peripheral;

FIG. 4 is an illustration showing a structure of communication services;

FIG. 5 is an illustration showing a structure of a print server;

FIG. 6 is a block diagram of a class structure of a protocol daemon management part;

FIG. 7 is a sequence chart of a process procedure for installing a protocol daemon;

FIG. 8 is a sequence chart of a process procedure for receiving print data; and

FIG. 9 is a sequence chart of a process procedure for uninstalling a protocol daemon.

### DETAILED DESCRIPTION OF THE PREFERRED EMBODIMENT

A description will be given below, with reference to the drawings, of an embodiment of the present invention. In the embodiment described below, a multi-function peripheral is an example of image forming apparatuses to which the present invention is applicable. The multi-function peripheral is an image forming apparatus, which can perform a plurality of functions such as a printing function, copy function, a scanner function, a facsimile function, etc., by a single unit. The present invention is not limited to such a multi-function peripheral, and applicable to any image forming apparatuses which are capable of executing a print job in accordance with a print request received according to a print protocol.

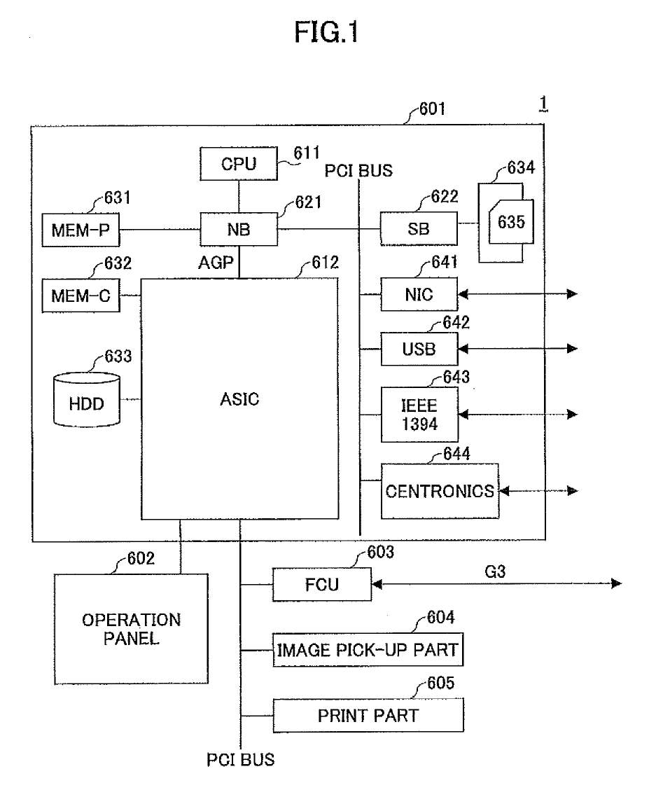

FIG. 1 is a block diagram of a hardware structure of the multi-function peripheral 1 according to the embodiment of the present invention. The hardware structure of the multi-function peripheral 1 includes a controller 601, an operation panel 602, a facsimile control unit (FCU) 603, an image pick-up part 604, and a print part 605.

The controller 601 includes a CPU 611, an ASIC 612, an NB 621, an SB 622, a MEM-P 631, a MEM-C 632, an HDD (hard disk drive) 633, a memory card slot 634, an NIC (network interface controller) 641, a USB device 642, an IEEE1394 device 643, and a Centronics device 644.

CPU 611 is an IC for various information processing. The ASIC 612 is an IC for various image processing operations. The NB 621 is a north bridge of the controller 601. The SB 622 is a south bridge of the controller 601. The MEM-P 631 is a system memory of the multi-function peripheral 1. The MEM-C 632 is a local memory of the multi-function peripheral 1. The HDD 633 is a storage device of the multi-function peripheral 1. The memory card slot 634 is a slot for setting a memory card 635. The NIC 641 is a controller for network communication according to a MAC address. The USB device 642 is a device for providing connection terminals according to the USD standard. The IEEE1394 device 643 is a device for providing connection terminals according to the IEEE1394 standard. The Centronics device 644 is a device for providing connection terminals according to the Centronics specification. The operation panel 602 serves as a hardware (operation device) for an operator to input various instructions and data to the multi-function device 1 and also serves as hardware (display device) from which the operator can acquire an output of the multi-function peripheral 1.

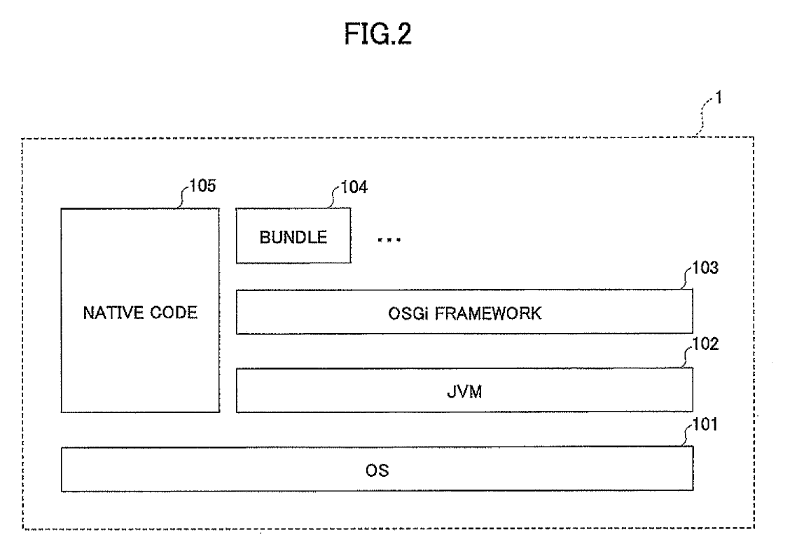

FIG. 2 is an illustration showing a software structure of the multi-function peripheral 1 according to the embodiment of the present invention.

In FIG. 2, the software structure of the multi-function peripheral 1 includes an OS (Operating System) 101, a JVM (Java (registered trademark) Virtual Machine) 102, an OSGi (Open Services Gateway Initiative) framework 103, a bundle 104, a native code 105, etc.

The OS 101 is a so-called operating system. The JVM 102 changes a Java (registered trademark) byte code into a native code, which can operate on the OS 101, and executes the native code. The OSGi framework 103 is a standardization technology according to the OSGi alliance, and is a software platform, which provides an execution circumstance of software parts created based on an open software part technology according to the Java (registered trademark) language. Software of the Java (registered trademark) language is mounted in the form of a software part referred to as a “bundle” on the OSGi framework 103. One bundle is constituted by one JAR (Java (registered trademark) ARchive) file, and it can be dynamically installed independently (without requiring re-starting of equipment). A bundle 104 corresponds to such a bundle. A plurality of bundles 104 may exist on the OSGi framework 103. The native code 105 is a program, which is described by the C language and can operate directly on the OS 101.

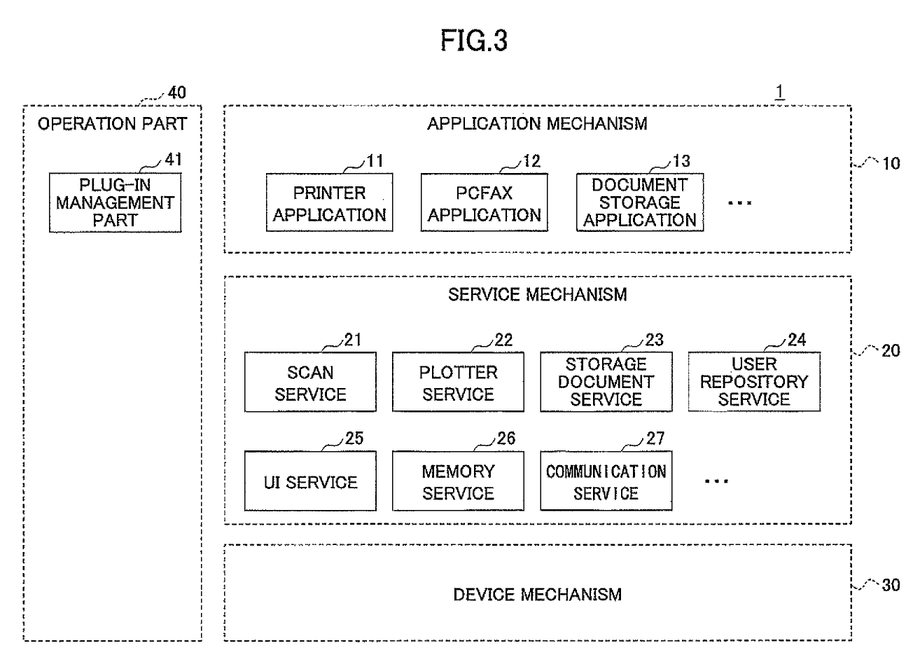

A software component is constituted in the multi-function peripheral 1 by the bundle 104 and the native code 105. FIG. 3 is an illustration showing a structure of the software component of the multi-function peripheral 1.

As shown in FIG, 3, the software component (hereinafter, simply referred to as “component”) in the multi-function peripheral 1 is classified into layers such as an application mechanism 10, a service mechanism 20, a device mechanism 30, an operation part 40, etc. The vertical relation of the layers in FIG. 3 is based on a call relation between the layers. Basically, a higher-order layer calls a lower-order layer. That is, in FIG. 3, the relationship between the components is set in order and indicated in accordance with the calling relationship between the bundle 104 or the native code 105. Each component is stored, for example, in the HDD 633, in order to be loaded to the MEM-P 631 at the time of execution and cause the CPU 611 to execute the function thereof.

A component as an application for making a user use resources, such as a function or information (data) provided by the multi-function peripheral 1, belongs to the application mechanism 10. A printer application 11, a PCFAX application 12 and a document storage application 13 are indicated as applications in FIG. 3.

The printer application 11 executes a printing process (print job) in response to a print request transmitted from a PC connected through the network. The PCFAX application 12 executes a facsimile transmitting process (facsimile transmitting job) in response to a facsimile transmission request transmitted through the network. The document storage application 13 controls a process for storing in the HDD 633 image data acquired by scanning by the image pick-up part 104.

Components belonging to the service mechanism 20 are used in common by the components belonging to the application mechanism 10 to provide more basic functions (services). In FIG. 3, there are indicated by an example a scan service 21, a plotter service 22, a storage document service 23, a user repository service 24, a UI service 25, a memory service 26 and a communication service 27.

The scan service 21 controls a reading process of image data performed by the image pick-up part 604. The plotter service 22 controls a printing process of the image data performed by the print part 605. The storage document service 23 controls a storing or accumulating process of the image data in the HDD 633 or read-out process of the image data from the HDD 633. The user repository service 24 manages user information (account information, address book information, etc.) stored in the HDD 633. The UI section 25 performs a display control of an operation screen to the operation panel 602, and performs detection of a user request input through the operation screen. The communication service 27 controls communication according to various kinds of protocols.

A component generally referred to as a device driver belongs to the device mechanism 30 to control the corresponding device provided in the multi-function peripheral 1.

A component, which is used for operation and management of the system, belongs to the operation part 40. The component in the operation part 40 is used in common by the application mechanism 10, the service mechanism 20 and the device mechanism 30. In FIG. 3, a plug-in management part 41 is provided in the operation part 40. The plug-in management part 41 manages installation and uninstallation of components, and also manages list information of installed components.

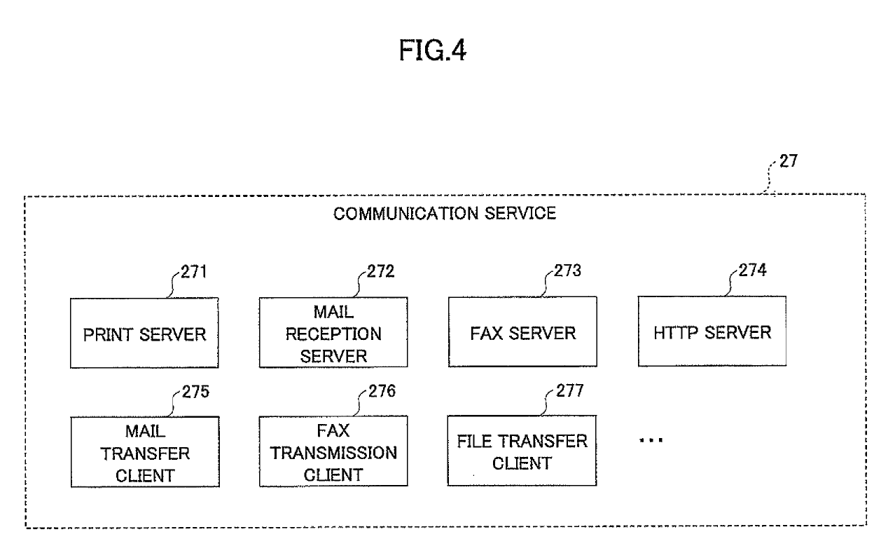

A description will be given below of the communication service 27 in the service mechanism 20 in further detail. FIG. 4 is an illustration showing a structure of the communication service. In FIG. 4, the communication service 27 includes a print server 271, a mail reception server 272, a facsimile (FAX) server 273, an HTTP (HyperText Transfer Protocol) server 274, a mail transmission client 275, a facsimile communication client 276, a file transfer client 277, etc. Each of the servers and clients is constituted by one bundle and a daemon (server program) or a client program according to a respective communication protocol.

The print server 271 controls reception of a print request according to various kinds of printing protocols. The mail reception server 272 controls a reception process of electronic mail. The facsimile server 273 controls a facsimile reception process. The HTTP server 274 controls communication according to HTTP. The mail transmission client 275 controls a transmitting process of electronic mail. The facsimile communication client 276 controls a facsimile transmitting process. The file transfer client 277 controls a transmission process of files according to FTP (File Transfer Protocol).

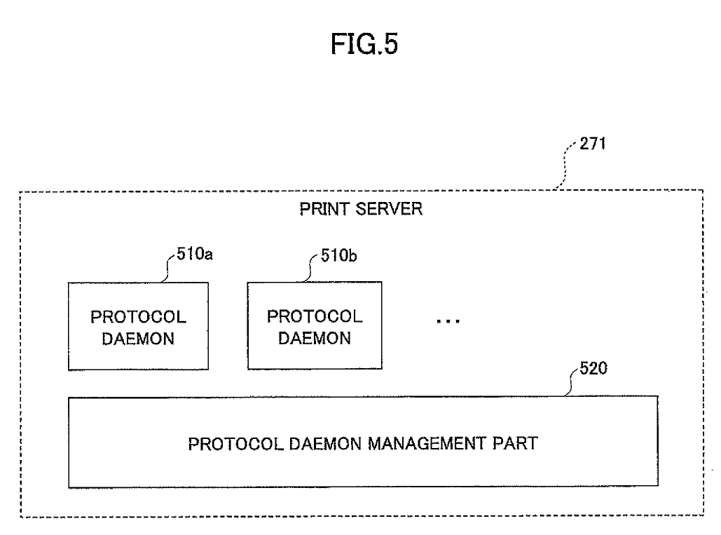

In the present embodiment, attention is paid to the print server 271. FIG. 5 is an illustration showing a structure of the print server 271. As illustrated in FIG. 5, the print server 271 includes one or more protocol daemons such as protocol daemons 501a and 510b (hereinafter, referred to as a protocol daemon 510 as a generic designation) and a protocol daemon management part 520.

Each protocol daemon 510 corresponds to a different print protocol and configured to receive a print request (print data) according to a respective print protocol. For example, the protocol daemon 510a is “lpd” (line printer daemon) and the protocol daemon 510b is “diprintd”. Each protocol daemon 510 is created according to an external specification specified between the protocol daemon management part 520. For example, each protocol daemon 510 has a previously determined interface (method). Moreover, each protocol daemon 510 is packaged according to a previously determined structure.

The protocol daemon management part 520 is one of the bundles, and performs a transfer of image data received by the protocol daemon 510 to the application (the printer application 11 and the PCFAX application 12). That is, the transmission of the print data between the protocol daemon 510 and the application is mediated by the protocol daemon management part 520. The protocol daemon management part 520 also performs control of installation and uninstallation of the protocol daemon 510.

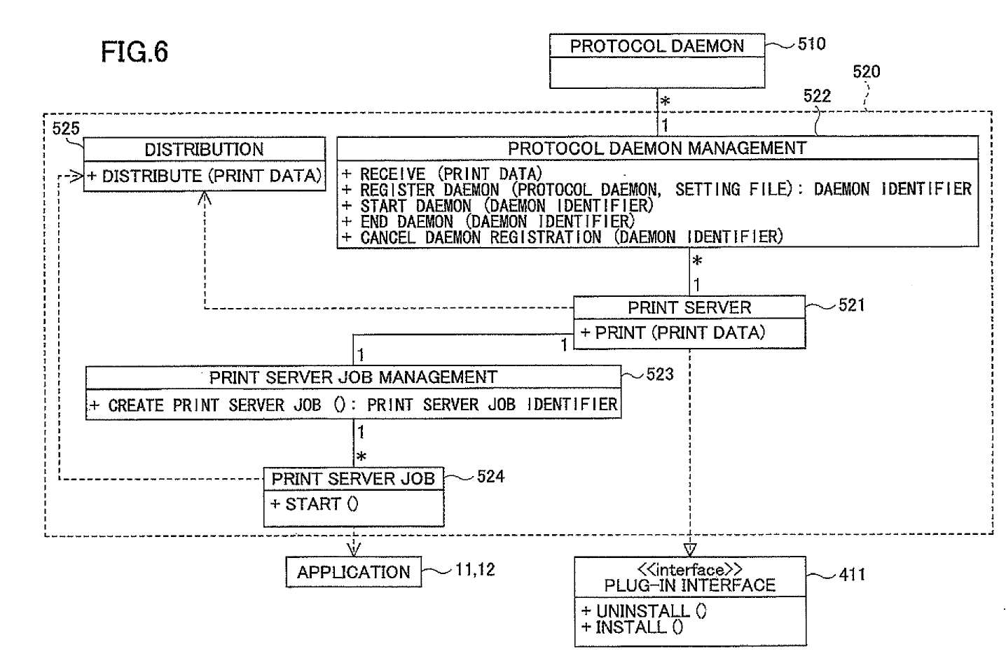

FIG. 6 is an illustration showing a class structure of the protocol daemon management part 520. In FIG. 6, the protocol daemon management part 520 includes a print server class 521, a protocol daemon management class 522, a print server job management class 523, a print server job class 524 and a distribution class 525.

The print server class 521 is a class serving as an interface to other components, and only one instance (print server object) thereof exists in the daemon management part 520. The print server class 521 is provided with a print method. The print method causes an execution of a job (hereinafter, referred to as a print server job) in the protocol daemon management part 520 to be started with respect to print data received by the protocol daemon 510. The print server job refers to a job regarding a process of transmitting the received print data to the application, and is distinguished from a job executed by the application based on the transmitted print data. The print server class 521 inherits the plug-in interface class 411. The plug-in interface class 411 is a class in which an interface to be mounted to all components constituted as bundles is defined in the multi-function peripheral 1. As such an interface, there is an uninstallation method and an installation method. Therefore, mounting of the uninstallation method and the installation method is defined in the print server class 521.

The protocol daemon management class 522 manages a correlation with the protocol daemon 510 and the protocol daemon management part 520, and serves as an interface to the protocol daemon 510. One instance (a protocol daemon management object) exists with respect to the print server object. One protocol daemon management object is related to one or more protocol daemons 510. The protocol daemon management class 522 includes a daemon registration method, a daemon start method, a daemon end method, a daemon registration cancel method, etc.

The daemon registration method installs the protocol daemon 510 designated as an argument. Thereby, the protocol daemon 510 concerned is usable through the daemon management part 520. The daemon start method causes the protocol daemon to be started. The daemon end method terminates causes the protocol daemon to be ended. The daemon registration cancel method uninstalls the protocol daemon 510 designated as argument.

The print server job management class 523 is a class which manages a print server job, and one instance (print server job management object) thereof exists with respect to the print server object. The print server job management class 523 is provided with a print server job creation method. The print server job creation method creates the print server job.

The print server job class 524 is a class expressing the print server job, and, the number of existing instances (print server job objects) thereof is equal to the number of print server jobs. The print server job class 524 is provided with a start method. The start method causes an execution of the print server job to start.

The distribution class 525 is a class which determines a destination application to which received print data is distributed or assigned. The distribution class 525 is provided with a distribution method. The distribution method determines the printer application 11 or the PCFAX application 12 as a destination application to which the print data is distributed based on contents of the received print data (information contained in a predetermined part of the print data).

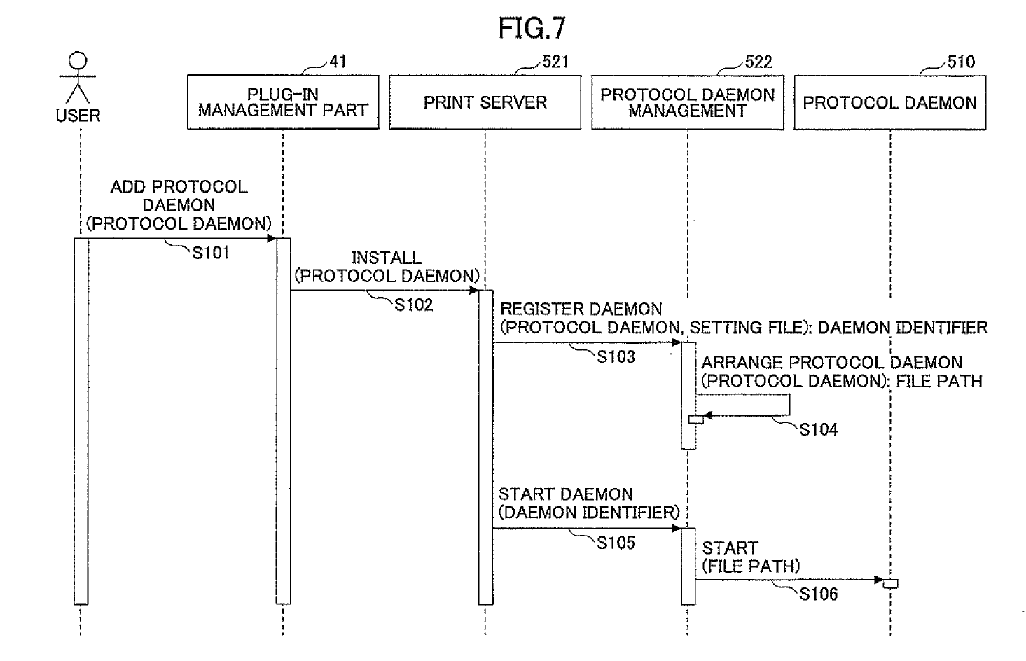

A description will be given below of a process procedure of the print server 271. FIG. 7 is a sequence chart for explaining a process procedure executed when installing a protocol daemon. In the sequence chart, an instance (object) of each class is given the same reference number as the class concerned.

When an instruction of installing the protocol daemon 510 is input by a user through the operation panel 602, the plug-in management part 41 is notified of the installation instruction (S101). The plug-in management part 41 designates an identification name (for example, a package name) of the protocol daemon 510 as an argument, and calls the installation method of the print server object 521 (S102). The print server object 521 designates the identification name of the designated protocol daemon 510 and the file name of the setting file contained in the package of the protocol daemon 510 as arguments, and calls a daemon registration method of the protocol daemon management object 522 (S103). The setting file is a file in which values of parameters, required by the protocol daemon 510 when executing, are set. The setting file contains, for example, a port number, a time-out time, etc. The format and the contents of the setting file may vary for each protocol daemon 510.

The protocol daemon management object 522 saves the execution format file and the setting file of the protocol daemon 510 contained in the package of the designated protocol daemon 510 in a predetermined folder, and assigns an identifier (hereinafter, referred to as a daemon identifier) to the newly installed protocol daemon 510 (S104). The protocol daemon management object 522 stores information regarding a relationship between the file name of the execution format file and the daemon identifier in the HDD 633. The daemon identifier is returned to the print server object 521 as a return value of the daemon registration method.

Then, the print server object 521 designates the daemon identifier as an argument, and calls a daemon start method of the protocol daemon management object 522 (S105). The protocol daemon management object 522 responds to the call from the daemon start method to start or activate the execution format file corresponding to the file name related to the designated daemon identifier (S106). Thereby, the installed protocol daemon 510 is started or activated as a process.

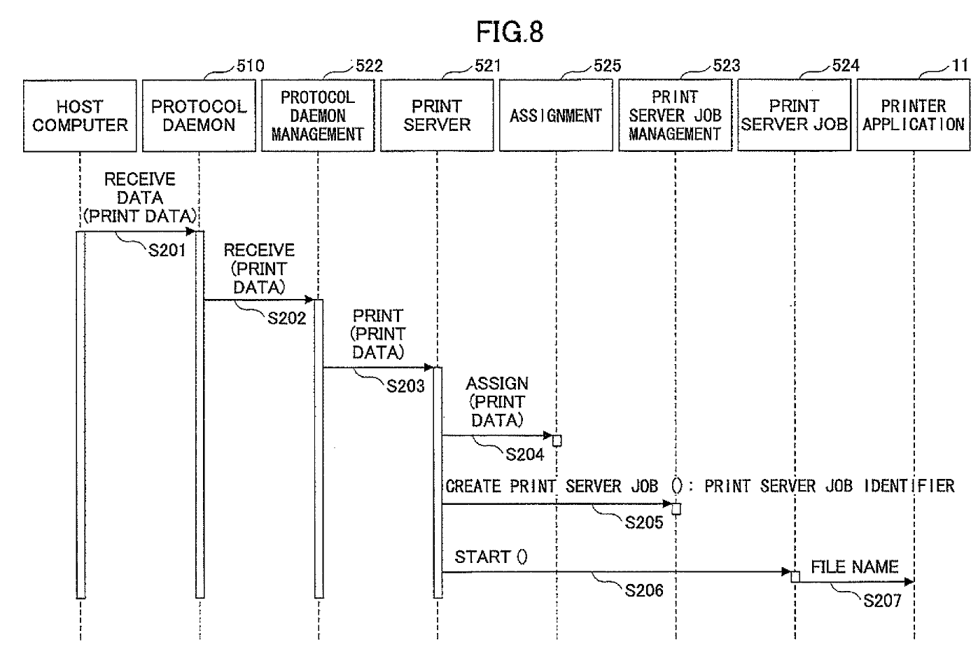

FIG. 8 is a sequence chart for explaining a process procedure executed when receiving print data. When print data is transferred from a host computer connected through a network, the protocol daemon 510 corresponding to the print protocol used for the transfer receives the print data (S201). The protocol daemon 510 spools or stores the received print data in the HDD 633 as a file, and calls a reception method of the protocol daemon management object 522 by using the file name as an argument (S202). In response to the call from the reception method, the protocol daemon management object 522 designates the designated file name as an argument, and calls a print method of the print server object 521 (S203).

In response to the call from the print method, the print server object 521 designates the designated file name as an argument, and calls a distribution method of the distribution object 525 (S204). In response to the call from the distribution method, the distribution object 525 refers to the file corresponding to the file name designated as an argument in order to determine a destination of distribution of the print data stored in the file concerned. If the print data concerned is the print data corresponding to the print request from a printer driver, it is determined that the destination of distribution is the printer application 11. If the print date concerned is the print data corresponding to a FAX transmission request from a client program for FAX transmission request in the host computer, it is determined that the destination of distribution is the PCFAX application 12. The distribution object 525 returns the application name of the application, which was determined as a destination of distribution, to the print server object 521 as a return value of the distribution method.

Then, the print server object 521 calls a print server job creation method of the print server job management object 523 (S205). In response to the call from the print server job creation method, the print server job management object 523 creates a print server job object 524 (S206), and returns identification information thereof (for example, reference) to the print server object 521 as a return value.

Then, the print server object 521 calls the start method of the print server job object 524 corresponding to the returned identification information (S206). The application name of the destination of distribution and the file name of the print data are designated as arguments of the start method. In response to the call from the start method, the print server job object 524 notifies the application designated as the destination of distribution (for example, the printer application 11) of the file name of the print data (S207). Thereafter, the printer application 11 reads the print data from the file corresponding to the notified file name, and executes the print process (print job) in accordance with the print data concerned.

Although the example of saving print data as a file was explained above, the print data may be stored in a shared memory. In such a case, the identification information as a file to which the print data is saved is not a file name but address information on the shared memory.

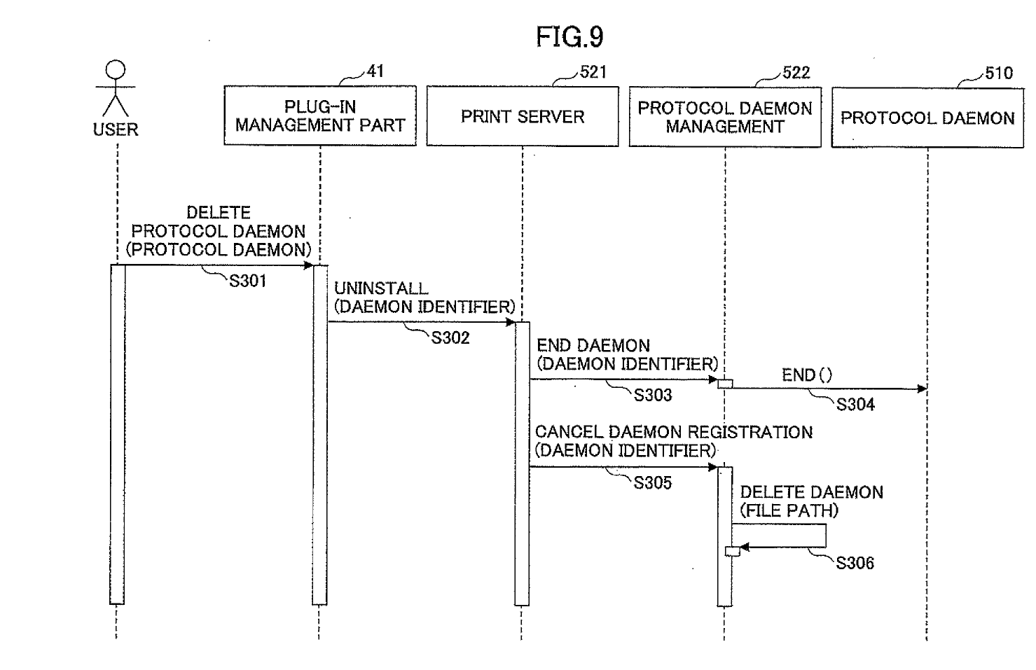

FIG. 9 is a sequence chart for explaining a process procedure executed when uninstalling a protocol daemon. When an instruction of uninstalling the protocol daemon 510 is input by a user through the operation panel 602, the plug-in management part 41 is notified of the uninstallation instruction (S301). The plug-in management part 41 designates a daemon identifier of the protocol daemon 510 corresponding to the uninstallation instruction as an argument, and calls an uninstallation method of the print server object 521 (S302). In response to the call from the uninstallation instruction, the print server object 521 designates the designated daemon identifier as an argument, and calls a daemon end method of the protocol daemon management object 522 (S303). In response to the call from the daemon end method, the protocol daemon management object 522 causes the process of the protocol daemon 510 corresponding to the designated identifier to end (S304).

Then, the print server object 521 designates the daemon identifier as an argument, and calls a daemon registration cancel method of the protocol daemon management object 522 (S305). In response to the call from the daemon registration cancel method, the daemon management object 522 deletes the execution format file, the setting file, etc., of the protocol daemon 510 corresponding to the designated daemon identifier from the HDD 633. Then, the uninstallation of the protocol daemon 510 is completed.

As mentioned above, according to the multi-function peripheral 1 according to the present embodiment, transmission of print data between the protocol daemon 510 and the application is mediated by the protocol daemon management part 520. Therefore, each application is not required to directly exchange a protocol daemon. In other words, there is no need to mount an exchange with a protocol daemon to each application. Specifically, in a case where the protocol daemon 510 is mounted by the native code and an application is mounted by Java (registered trademark) r the complicated exchange by JNI (Java (registered trademark) Native Interface) with the native code is consolidated into the protocol daemon management part 520.

Moreover, if a change is needed for the interface of the protocol daemon 510, the correspondence to the change concerned is limited to the protocol daemon management part 520, and there is no need to correct each application.

Further, life cycle management of the protocol daemon 510, such as an installation, an uninstallation, and a start and end of execution of the protocol daemon 510, is performed solely by the protocol daemon management part 520. Therefore, even if the specification regarding management of the life cycle is changed, the influence is absorbable by the protocol daemon management part 520.

The above-mentioned process procedure according to the present embodiment may be described by a computer readable program. The computer readable program is stored in a computer readable recording medium such as the HDD 633 illustrated in FIG. 1, and is read by the CPU 611 of the multi-function peripheral 1 illustrated in FIG. 1. Thus, the multi-function peripheral 1 as an example of an image forming apparatus can execute the process procedure according to the above-mentioned embodiment shown in FIGS. 7, 8 and 9.

The present invention is not limited to the specifically disclosed embodiments, and variations and modifications may be made without departing from the scope of the present invention.

The present application is based on Japanese priority application No. 2007-316130 filed Dec. 6, 2007, the entire contents of which are hereby incorporated herein by reference.

What is claimed is:

1. An image forming apparatus having at least one job execution part that executes a job based on data received according to a print protocol, the image forming apparatus comprising:
a data reception part configured to receive data transferred according to said print protocol, the data reception part existing depending on a kind of said print protocol; and
a mediation part configured to mediate transmission of the data between said data reception part and said job execution part.

2. The image forming apparatus as claimed in claim 1, comprising a plurality of said job execution parts, wherein said mediation part determines one of said job execution parts to which the data is transmitted in accordance with contents of the data.

3. The image forming apparatus as claimed in claim 1, wherein said mediation part executes a start of a program that realizes said data reception part.

4. The image forming apparatus as claimed in claim 3, wherein said mediation part executes an end of the program that realizes said data reception part.

5. An information processing method performed by an image forming apparatus having at least one job execution part that executes a job based on data received according to a print protocol, the information forming method comprising:
a data reception procedure to receive data transferred according to said print protocol by a data reception part existing depending on a kind of said print protocol; and
a mediation procedure executed by a mediation part to mediate transmission of the data between said data reception part and said job execution part.

6. The information processing method as claimed in claim 5, wherein said image forming apparatus includes a plurality of said job execution parts, and said mediation part determines one of said job execution parts to which the data is transmitted in accordance with contents of the data.

7. The information processing method as claimed in claim 5, wherein said mediation part executes a procedure to start a program that realizes said data reception part.

8. The information processing method as claimed in claim 7, wherein said mediation part executes a procedure to end the program that realizes said data reception part.

9. A computer readable recording medium storing a program to cause an image forming apparatus, which has at least one job execution part that executes a job based on data received according to a print protocol, to execute:
a data reception procedure to receive data transferred according to said print protocol by a data reception part existing depending on a kind of said print protocol; and
a mediation procedure executed by a mediation part to mediate transmission of the data between said data reception part and said job execution part.

10. The computer readable recording medium as claimed in claim 9, wherein said image forming apparatus includes a plurality of said job execution parts, and said mediation part determines one of said job execution parts to which the data is transmitted in accordance with contents of the data.

11. The computer readable recording medium as claimed in claim 9, wherein said mediation part executes a procedure to start a program that realizes said data reception part.

12. The computer readable recording medium as claimed in claim 11, wherein said mediation part executes a procedure to end the program that realizes said data reception part.
